(19) United States
(12) Patent Application Publication
(10) Pub. No.: US 2022/0389291 A1
(43) Pub. Date: Dec. 8, 2022

(54) REDOX INITIATION SYSTEM FOR ACRYLIC ADHESIVES

(71) Applicant: LORD Corporation, Cary, NC (US)

(72) Inventors: Jian-Ping HUANG, Cary, NC (US); Timothy Perry, Chapel Hill, NC (US)

(21) Appl. No.: 17/794,731

(22) PCT Filed: Jan. 22, 2021
(86) PCT No.: PCT/US2021/014511

§ 371 Date: Jul. 22, 2022

Related U.S. Application Data
(60) Provisional application No. 62/964,754, filed on Jan. 23, 2020.

(51) Int. Cl. C09J 133/08; C09J 11/06; C09J 11/04; C08K 3/014; C08K 5/14; C08K 5/17

(52) U.S. Cl. CPC C09J 133/08; C09J 11/06; C09J 11/04; C08K 3/014; C08K 5/14; C08K 5/17

(57) ABSTRACT

A curable composition including a reactive monomer or oligomer with acrylate functionality, an amine, and an alkyl peroxide. The alkyl peroxide is free or substantially free of phenyl rings. The alkyl peroxide can be dilauroyl peroxide (DLP). The curable composition can also include 3,5-diethyl-1,2-dihyrdro-1-phenyl-2-propylpyridine (PDHP). The curable composition can be provided as a two-part adhesive composition, including an A-side with DLP and an acrylic monomer, and a B-side with PDHP.

### CROSS-REFERENCE TO RELATED APPLICATION

This application claims priority to U.S. Provisional Patent Application Ser. No. 62/964,754, filed Jan. 23, 2020, herein incorporated by reference in its entirety.

### TECHNICAL FIELD

The disclosure herein relates to initiation systems for acrylic adhesives which are free or essentially free of benzene and benzene derivative residues.

### BACKGROUND

Conventional acrylic structural adhesives typically comprise a mixture of one or more olefinic reactive monomers such as methyl methacrylate and methacrylic acid and a redox initiator system to cure the reactive monomers. They are typically delivered in two-part systems with the primary reactive monomers in the A-side and curative in the B-side. The initiator system includes at least one oxidizing agent, typically in the B-side and at least one reducing agent in the A-side. This system is co-reactive at ambient conditions on mixture of Parts A and B to initiate chain polymerization reactions and cure the acrylic adhesive.

In addition, fully formulated acrylic structural adhesives typically contain other additives for improving adhesion to substrate materials, environmental resistance, impact strength, flexibility, heat resistance, and the like. Epoxy resins impart improved heat resistance.

The most typical oxidizing agent in acrylic adhesives is benzoyl peroxide (BPO). BPO contains trace amount of benzene and its derivatives (toluene, xylene, or ethyl benzene) due to its natural decay, or thermal decomposition. When BPO is formulated into an acrylic curative, these harmful compounds will accumulate with time and pose a potential environmental, health, and safety (EH&S) danger.

Government EH&S regulations are evolving to become more stringent. One common EH&S initiative is to reduce chemical products' volatile organic compounds (VOCs). Among the most undesirable VOCs are benzene and its derivatives like toluene, xylene, ethyl benzene and styrene. In some regions, any chemical products like adhesives and sealants are required to pass strict industrial standards that include the reduction or elimination of benzene and benzene derivative residues.

Commercial structural adhesives are often found to contain benzene and its derivatives both in the “wet” adhesive and after cure. Thus, there is a need to provide robust structural adhesives that are essentially free or completely free of benzene and its derivatives. It is to this need that the embodiments of the disclosure herein are directed.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this Summary does not list or suggest all possible combinations of such features.

Thus, provided herein in some embodiments are curable compositions, the compositions comprising a reactive monomer or oligomer, the reactive monomer or oligomer having acrylate functionality, an amine, and an alkyl peroxide, the alkyl peroxide being free or substantially free of phenyl rings. The alkyl peroxide can in some aspects comprise an alkyl diacyl peroxide, optionally dilauroyl peroxide (DLP). In some embodiments, such curable compositions can further comprise 3,5-diethyl-1,2-dihyrdro-1-phenyl-2-propylpyridine (PDHP).

Provided herein in some embodiments are two-part adhesive compositions, the two-part adhesive compositions comprising an A-side comprising dilauroyl peroxide (DLP) and an acrylic monomer, and a B-side comprising 3,5-diethyl-1,2-dihyrdro-1-phenyl-2-propylpyridine (PDHP). In some aspects, the two-part adhesive compositions can further comprise a stabilizer, optionally wherein the stabilizer comprises Ethanox 330. In some aspects, the DLP is present from about 0.5 weight percent to about 5.0 weight percent based on the total weight of the composition, optionally wherein the DLP is present at about 1.0 weight percent to about 2.5 weight percent based on the total weight of the composition. In some embodiments, the PDHP is present from about 0.01 weight percent to about 1.0 weight percent based on the total weight of the composition, optionally the PDHP is present at about 0.1 weight percent based on the total weight of the composition.

These and other objects are achieved in whole or in part by the presently disclosed subject matter. Further, objects of the presently disclosed subject matter having been stated above, other objects and advantages of the presently disclosed subject matter will become apparent to those skilled in the art after a study of the following description and Examples.

### DETAILED DESCRIPTION

The presently disclosed subject matter now will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

### I. Definitions

The terminology used herein is for the purpose of describing particular embodiments only and is not intended to be limiting of the presently disclosed subject matter.

While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art. While the following terms are believed to be well understood by one of ordinary skill in the art, the following definitions are set forth to facilitate explanation of the presently disclosed subject matter.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the disclosure herein and the claims.

Following long-standing patent law convention, the terms “a”, “an”, and “the” refer to “one or more” when used in this application, including the claims. Thus, for example, reference to “a component” includes a plurality of such components, and so forth.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, dose, sequence identity (e.g., when comparing two or more nucleotide or amino acid sequences), mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

### II. Redox Initiation System for Acrylic Adhesives

The source of benzene and its derivatives in structural adhesives was identified to be primarily from the oxidizer, BPO. Further, since BPO is shock sensitive, commercial suppliers often add a stabilizer to the BPO and these stabilizers often contain benzene or benzene derivatives.

The decomposition of BPO after extracting a hydrogen atom from its surroundings results in Benzoic acid and ultimately Benzene. This process takes place naturally due to thermal decomposition during storage or throughout shelf life.

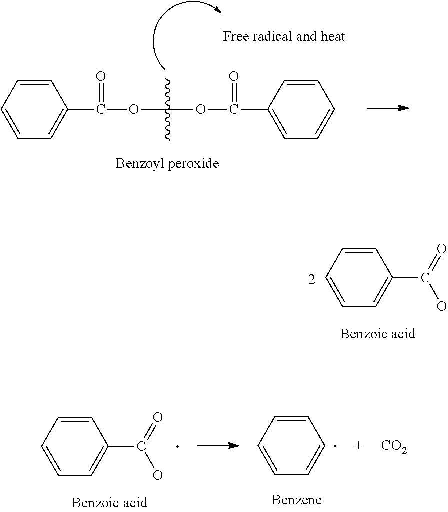

### Decomposition of BPO

In a first embodiment of the presently disclosed subject matter, an oxidizer for redox initiated acrylic resins is provided wherein the oxidizer is free of phenyl rings. Without being bound by any particular theory or mechanism of action, a lack of phenyl rings in the oxidizer can in some aspects lead to an absence of benzene or benzene derivatives in the cured adhesive. Additionally, an oxidizer that is less shock-sensitive than BPO will not require a stabilizer, thereby removing another common benzene source. This will provide a more EH&S compliant adhesive product.

In one embodiment of the presently disclosed subject matter, a preferred oxidizer comprises an alkyl diacyl peroxide, in some aspects preferably dilauroyl peroxide (DLP). DLP was found to undergo room temperature redox decomposition in the presence of a primary tertiary amine and a secondary tertiary amine, initiating polymerization of an acrylic resin system (A-side). In one embodiment of the presently disclosed subject matter comprising a two-part adhesive formulation, the DLP can be present in the B-side of the adhesive formulation from about 5 to about 10 weight percent, preferably about 8 weight percent, based on the weight of the B-side.

In another embodiment of the presently disclosed subject matter, an acrylic adhesive is provided comprising a very low content of residual benzene and benzene derivatives. Generally, this is understood to be less than about 300 mg/km, more preferably less than about 30 mg/kg, and most preferably less than about 3 mg/kg. In a preferred embodiment of the presently disclosed subject matter, the adhesive can be substantially free, e.g. less than about 10%, less than about 5%, less than about 1%, less than about 0.5%, or less than about 0.1%, and more preferably completely free of benzene and benzene derivatives. In a further embodiment of the presently disclosed subject matter, an acrylic adhesive comprising a very low or no residual aldehyde content/residue is also preferred. Most preferred is a system with less than about 100 ppm aldehyde content/residue.

However, when paired with traditional amine accelerators used in acrylic adhesives the disclosed adhesive compositions can be slow to cure. As such, an accelerator uniquely suited for use with DLP was introduced.

In a further embodiment of the presently disclosed subject matter, the cure was accelerated by the introduction of 3,5-diethyl-1,2-dihyrdro-1-phenyl-2-propylpyridine (PDHP). When a small amount of PDHP was introduced, DLP's decomposition was surprisingly and effectively sped up. The PDHP is responsible for decomposing DLP at room temperature. The cure time can be tuned from about 3 minutes to about 30 minutes depending on the composition of this system. In one embodiment of the presently disclosed subject matter, the PDHP can be present from about 0.01 weight percent to about 1.0 weight percent based on the total weight of the composition, and typically present in the “A-side” of a two-part adhesive formulation to keep it separate from the DLP.

### III. Acrylic Adhesive Compositions

In an additional embodiment of the presently disclosed subject matter, the oxidizer and accelerator recited above can be employed in acrylic adhesion compositions which are generally known to the art and to the literature and typically include one or more free radical polymerizable monomers, at least one rubber toughener, optionally fillers, coloring agents, and one or more speed control agents to control the open time (the time between application of the mixed adhesive and the time when bonding performance is compromised because of advancing cure), and oxygen barriers, e.g. waxes.

In another embodiment of the presently disclosed subject matter, the DLP and PDHP are present in an adhesive composition including as principal components: (a) about 10% to about 90% by weight of at least one free radical-polymerizable monomer, (b) about 0% to about 20% by weight of an adhesion promoter, (c) about 10% to about 80% by weight of a primary low molecular weight toughener (or toughening agent) with a weight average molecular weight (M_{w}) less than about 18,000 or a number average molecular number (Mₙ) less than about 10,000 and; (d) about 1% to about 15% by weight of an auxiliary high molecular weight toughener (or toughening agent) with a M_{w} greater than about 18,000, and preferably as high as 100,000 to 120,000 or a Mₙ greater than about 10,000 based on the total weight of components (a)-(d).

(Meth)acrylic-based monomers and/or polymers derived from (meth)acrylic-based monomers are particularly useful as at least part of the polymerizable component. As used herein, (meth)acrylic-based monomer means acrylic acid, methacrylic acid or an amide, ester, salt or nitrile thereof. Representative (meth)acrylic-based monomers include, but are not limited to, methyl methacrylate, ethyl methacrylate, butyl methacrylate, methyl acrylate, butyl acrylate, cyclohexyl acrylate, hexyl acrylate, 2-ethylhexyl acrylate, lauryl acrylate, ethyl acrylate, diethylene glycol dimethacrylate, dicyclopentadienyloxyethyl methacrylate, 2-ethylhexyl methacrylate, hexyl methacrylate, cyclohexyl methacrylate, lauryl methacrylate, tetrahydrofuryl methacrylate, methacrylic acid, acrylic acid, acrylonitrile, methacrylonitrile, glycidyl methacrylate, cyanoacrylate, acrylamide and methacrylamide.

Representative embodiments include 2-part acrylic structural adhesives comprising, in a first package from about 10% to about 90% by weight of at least one methacrylate selected from C₃-C₁₀ alkyl monosubstituted-, C₁-C₆ alkyl disubstituted-, C₁-C₄ alkyl tri-substituted, and C₁-C₄ alkyl tetra-substituted cyclohexyl methacrylate. The ring substituents are preferably in the 3, 4, and/or 5 ring position, and linear or branched C₄-C₁₄ branched alkyl methacrylates; from about 10% to about 80% by weight of a toughener, and an adhesion promoter; and in a second package, a bonding activator, and optional epoxy resin.

In an additional embodiment of the presently disclosed two-part adhesive formulations, it can in some aspects be advantageous to “switch” the oxidizer from a traditional, B-side component to the A side of a two-part adhesive. In a particular embodiment of the presently disclosed subject matter, DLP can be included in the “A-side” of the adhesive and PDHP in the “B-side”.

In a further embodiment of the presently disclosed subject matter, a stabilizer or antioxidant can be included along with the DLP to prevent any unwanted decomposition of the DLP from reacting with the monomers present in the A-side. While any suitable stabilizer or antioxidant can be used, in a preferred embodiment, the stabilizer can comprise Ethanox 330, having the structure below, available from SI Group, Inc.

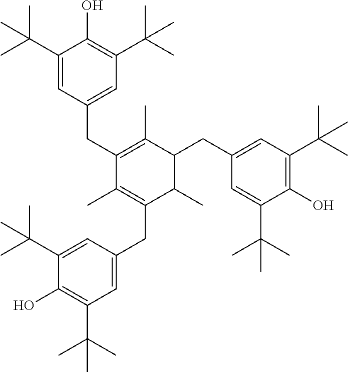 [SMILES: CC1=C(Cc2cc(C(C)(C)C)c(O)c(C(C)(C)C)c2)C(C)C(Cc2cc(C(C)(C)C)c(O)c(C(C)(C)C)c2)C(C)=C1Cc1cc(C(C)(C)C)c(O)c(C(C)(C)C)c1]

### Ethanox 330

Other stabilizers suitable for use in an embodiment of the presently disclosed subject matter include, by way of example and without limitation, p-benzoquinone, Ethaphos 368, and toluhydroquinone.

The stabilizer is preferably present in an amount from about 0 ppm (parts per million) to about 500 ppm in the adhesive, and most preferably in an amount from about 125 ppm to about 250 ppm.

Thus, provided herein in some embodiments are curable compositions, the compositions comprising a reactive monomer or oligomer, the reactive monomer or oligomer having acrylate functionality, an amine, and an alkyl peroxide, the alkyl peroxide being free or substantially free of phenyl rings. The alkyl peroxide can in some aspects comprise an alkyl diacyl peroxide, optionally dilauroyl peroxide (DLP). In some embodiments, such curable compositions can further comprise 3,5-diethyl-1,2-dihyrdro-1-phenyl-2-propylpyridine (PDHP).

The DLP can be present from about 0.5 weight percent to about 5.0 weight percent based on the total weight of the composition, or from about 1.0 weight percent to about 2.5 weight percent based on the total weight of the composition. The PDHP can be present from about 0.01 weight percent to about 1.0 weight percent based on the total weight of the composition, or about 0.1 weight percent based on the total weight of the composition.

In some embodiments, the compositions can be substantially free from any phenyl containing constituents. In some embodiments, the compositions can be cured or curable. In some embodiments, the compositions can be substantially free from benzene or benzene derivatives, e.g. less than about 5%, less than about 1% or less than about 0.5%. In some embodiments, the compositions can be completely free from benzene or benzene derivatives. In some embodiments, the compositions can comprise low or substantially no residual aldehyde content or residue, optionally wherein the compositions have less than about 100 ppm aldehyde content or residue.

In some embodiments, the compositions can further comprise diisopropanol toluidine and dimethyl piperazine. In some embodiments, the compositions can comprise a two-part adhesive, the two part-adhesive comprising the DLP and the acrylic monomer in an A-side, and the PDHP in a B-side. In some embodiments, the compositions can further comprise a stabilizer, optionally wherein the stabilizer comprises Ethanox 330.

Provided herein in some embodiments are two-part adhesive compositions, the two-part adhesive compositions comprising an A-side comprising dilauroyl peroxide (DLP) and an acrylic monomer, and a B-side comprising 3,5-diethyl-1,2-dihyrdro-1-phenyl-2-propylpyridine (PDHP). In some aspects, the two-part adhesive compositions can further comprise a stabilizer, optionally wherein the stabilizer comprises Ethanox 330. In some aspects, the DLP is present from about 0.5 weight percent to about 5.0 weight percent based on the total weight of the composition, optionally wherein the DLP is present at about 1.0 weight percent to about 2.5 weight percent based on the total weight of the composition. In some embodiments, the PDHP is present from about 0.01 weight percent to about 1.0 weight percent based on the total weight of the composition, optionally the PDHP is present at about 0.1 weight percent based on the total weight of the composition.

In some embodiments, the two-part adhesive compositions can be substantially free from any phenyl containing constituents. In some embodiments, the two-part adhesive compositions can be substantially free from benzene or benzene derivatives. In some embodiments, the two-part adhesive compositions can have low or substantially no residual aldehyde content or residue, optionally wherein the composition has less than about 100 ppm aldehyde content or residue. In some embodiments, the two-part adhesive compositions further comprise diisopropanol toluidine and dimethyl piperazine.

### EXAMPLES

The following examples are included to further illustrate various embodiments of the presently disclosed subject matter. However, those of ordinary skill in the art should, in light of the present disclosure, appreciate that many changes can be made in the specific embodiments which are disclosed and still obtain a like or similar result without departing from the spirit and scope of the presently disclosed subject matter.

### Example 1

### Evaluating a Two-Part Acrylic Adhesive

In this Example, a two-part acrylic adhesive was prepared wherein the B-side curative, designated E029-8, was formulated with a dilauroyl peroxide (DLP), e.g., Luperox LP (Arkema Inc), rather than benzoyl peroxide as is typical in such adhesives. See Table 1.

TABLE 1

| Component | E029-8 | Batch (g) | X2 | Batch (g) |
|---|---|---|---|---|
| Luperox LP | 7.6 | 7.612 | 15.2 | 15.20 |
| Benzoate | 4.50 | 4.510 | 9.00 | 9.02 |
| preservative | | | | |
| Epoxy resin | 43.70 | 43.710 | 87.40 | 87.49 |
| Filler | 36.70 | 36.70 | 73.4 | 73.41 |
| (mineral) | | | | |
| Filer (glass) | 1.00 | 1.032 | 2.00 | 2.00 |
| Fumed silca | 1.5 | 1.507 | 3.00 | 3.01 |
| Total | 95.00 | 95.071 | 190.00 | 190.12 |

The A-side, designated 8006-2, comprises a typical A-side acrylic structural adhesive comprising acrylate monomers, HEMA-phosphate, DIIPT (diisopropanol toluidine) and DMP (dimethyl piperazine), and additives such as tougheners, inhibitors, waxes, fillers such as fumed silica, etc. See Table 1.

The A- and B-sides were paired at a 4:1 (A:B) mix ratio by volume. While this mixture did cure, the cure rate was extremely sluggish. Additionally, the air inhibition on the squeeze-out was severe (See Table 2 below).

### Example 2

### The Surprising Effect of Adding PDHP

An attempt was made to identify potential accelerators to make the DLP/acrylic cure proceed more quickly. After spiking Cobalt Naphthenate solution (6% Cu, Alfa Aesar) and Copper Naphthenate (8% Co, The Shepherd Chemical Company) into above mixture, no effect was observed.

Then, 3,5-diethyl-1,2-dihyrdro-1-phenyl-2-propylpyridine (PDHP) was added in A/B-mixture, including for example at about 0.50 wt %, or at a range of about 0.01 wt % to about 0.70 wt %.

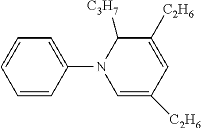

### 3,5-diethyl-1,2-dihyrdro-1-phenyl-2-propylpyridine (PDHP)

Adding small amounts of PDHP into the adhesive mixture surprisingly sped up the cure and achieved a solid cure. Additionally, it was discovered that the cure time could be adjusted by varying the amount of PDHP added to or incorporated in the mixture. Moreover, the air inhibition was significantly reduced with the inclusion of varying amounts of PDHP. See Table 2.

TABLE 2

| Luperox LP | DHPT_DMP_PDHP | Cure Time (min) | Air Inhibition |
|---|---|---|---|
| 8006-2/E029-8 | 0.86/0.65/0.00 | 75 | Bad |
| 8006-2_2/E029- | 0.95/0.95/0.00 | 40 | Bad |
| 8 | | | |
| 8006-2_3/E029- | 0.95/0.95/0.65 | 1 | Minimal |
| 8 | | | |
| 8006-2_4/E029- | 0.95/0.95/0.30 | 1.4 | Minimal |
| 8 | | | |
| 8006-2_5/E029- | 0.95/0.95/0.10 | 3.5 | Some |
| 8 | | | |
| 8006-2_6/E029- | 0.95/0.95/0.05 | 3.5 | Some |
| 8 | | | |
| 8006-2_7/E029- | 0.86/0.65/0.05 | 3.5 | Some |
| 8 | | | |
| 8006-2_8/E029- | 0.86/0.65/0.01 | 20 | Bad |
| 8 | | | |
| 8006-2_9/E029- | 0.86/0.65/0.025 | 6 | Some |
| 8 | | | |
| 8006- | 0.86/0.65/0.0375 | 4 | Some |
| 2_10/E029-8 | | | |

### Example 3

### Evaluation of Adhesive Properties

In this experiment, adhesive properties like lap shear and T-peel on aluminum were observed. Reasonably acceptable lap shear strength and T-peel strength were obtained the adhesive formulas provided herein. For this particular application, preferred lap shear can be about 1700-2200 psi with non-adhesive failure, and T-peel in the 20-38 pli range with no adhesive failure. See Table 3.

TABLE 3
Preliminary Lap Shear and T-peel testing

| | 8006-2-9 | 8006-2-10 |
|---|---|---|
| | E029-8 | E029-8 |
| Lap Shear (lbs) | 933.21 | 1020.58 |
| Lap Shear (psi) | 1866.42 | 2041.16 |
| Failure | 100tlc | 40c60tlc |
| T-peel (pli) | 17.55 | 14.64 |
| Failure | 50c50tlc | 100tlc |

Cure Conditions: RT + overnight
Substrate: T6 6061 Aluminum

While the system in this example exhibited good bonding, the shelf life was poor due to the PDHP reacting with other constituents during storage.

### Example 4

### Evaluation of Adhesive Compositions as a Plastic Bonder

The following example demonstrates the effectiveness of the disclosed adhesive compositions in a plastic bonding system. The metal adhesion promotors like HEMA-phosphate, the mono-ester of phthalic anhydride, and HEMA were removed. The preliminary data showed that the A-side stays fluid and bond strength on acrylonitrile butadiene styrene (ABS) is sound. See Table 4.

TABLE 4

| Formulation | PDHP Level | LP Level | TDMA | psi |
|---|---|---|---|---|
| E036-7_E036-2 | 0.4 | 6.9 | 0.0 | 158 |
| E036-7_E036-6 | 0.4 | 13.7 | | 177 |
| E036-11_E036-2 | 0.8 | 6.9 | | 155 |
| E036-11_E036-6 | 0.8 | 13.7 | | 181 |
| E036-13_E036-2 | 0.4 | 6.9 | 0.1 | 156 |
| E036-13_E036-6 | 0.4 | 13.7 | | 138 |
| E036-15_E036-2 | 0.8 | 6.9 | | 169 |
| E036-15_E036-6 | 0.8 | 13.7 | | 181 |

* Plastic substrate: AB, IPA wipe, light scuffing with 3M scuff pad

All systems obtained greater than 150 psi strength, while not optimal, confirms adhesive cure at RT condition. It is worth noting that these systems were not optimized.

### Example 5

### Evaluation of DLP in A-Side Component

In this example, switching the DLP and PDHP between the A and B-sides was investigated. The goal was to obtain a viable system that will have a reasonable shelf life by removing PDHP complexing with active-hydrogen containing ingredients in the A-side.

For the side-switch approach, a model solution of PDHP in GY1556 epoxy resin at 5.5 wt % was made. Its fluidity was monitored with time. This solution was monitored for three weeks and stayed fluid at room temperature, showing little adverse interaction between PDHP and the epoxy resin.

A model solution of DLP in t-MCHMA at 4 wt % was also made. It was stored at room temperature (RT) and in a 50° C. oven. The latter gelled in 24 hours while the RT solution stays fluid for three weeks but with a slight discoloration. The lab temperature was in the range of 18-21° C. While it may not be practical to store an A-side resin in a cold room, a low temperature storage can lengthen the shelf life.

The bonded parts are first cured at RT condition, then post-baked at 175° C. for 30 min to mimic the e-bake. The results showed impressive T-peel performance while using the two rubber adducts. The effect of LP and PDHP was also studied for understanding the performance space. See Table 5.

TABLE 5

| | A-side | B-side | | |
|---|---|---|---|---|
| | LP Level | PDHP Level | T-peel | Failure |
| | | | R45HT | |
| E034M_E034-6 | 1.35 | 0.4 | 17.31 | 100c |
| E034M_E034-7 | 1.35 | 0.2 | 19.14 | 100c |
| E034-9_E034-8 | 1.35 | 0.1 | 25.56 | 100tlc |
| | | | GMA/CTB | |
| E034-10_E034-8 | 1.35 | 0.1 | 33.4 | 100tlc |
| E034-10_E034-12 | 1.35 | 0.3 | 28.9 | 100tlc |
| E034-11_E034-12 | 2.7 | 0.3 | 36.49 | 100c |

### Example 6

### Evaluation of Stability of Adhesive Compositions

The example above demonstrates that by swapping Luperox LP and PDHP in the conventional A- and B-sides, the quick and strong interaction between PDHP and the H-donating components like HEMA, HEMA-phosphate, and others can be substantially or completely avoided. However, putting the LP peroxide in the resin side (A-side) is known to be problematic; the natural decomposition of peroxide would cause monomers and intermediates to polymerize and result in gelation.

Based on the instant disclosure, and without being bound by any particular theory or mechanism of action, it was concluded that PDHP is stable on the B side since there are no active hydrogen containing raw materials on this side. No adverse effects of placing PDHP on the B side were observed. There was concern that the DLP on the A side might have stability issues since it was expected that the peroxide would react with acrylic monomers over time. To overcome this issue a stabilizer, e.g. Ethanox 330, was added to the A-side and the new adhesive formulations were examined alongside a traditional adhesive containing BPO as a control with equivalent levels of DLP and BPO. The cups were placed in a 25° C. incubator and monitored over time. The following observations were made: 1) after two weeks, both the DLP and BPO containing samples remained fluid with little/no observable color change; 2) after three weeks, while both samples were still fluid, the BPO containing sample was noticeably darker/browner in color than the DLP containing sample indicating some reaction/gelation of the monomers; 3) after 2 months, the BPO containing sample was a darker brown and had begun to visibly gel, while the DLP containing fluid was only slightly darkening; and 4) after 2.5 months, the BPO containing fluid was about 50% gelled, while the DLP containing fluid appeared unchanged from earlier observations.

The conclusion was that Luperox LP containing system is stable at 25° C. for several months with Ethanox 330 at 10 ppm, while the BPO-containing system begins to gel and become unusable.

It will be understood that various details of the presently disclosed subject matter may be changed without departing from the scope of the presently disclosed subject matter. Furthermore, the foregoing description is for the purpose of illustration only, and not for the purpose of limitation.

1. A curable composition, the composition comprising:
a reactive monomer or oligomer, the reactive monomer or oligomer having acrylate functionality;
an amine; and
an alkyl peroxide, the alkyl peroxide being free or substantially free of phenyl rings.

2. The composition of claim 1, wherein the alkyl peroxide comprises an alkyl diacyl peroxide.

3. The composition of claim 1, wherein the alkyl peroxide comprises dilauroyl peroxide (DLP).

4. The composition of claim 1, further comprising 3,5-diethyl-1,2-dihyrdro-1-phenyl-2-propylpyridine (PDHP).

5. The composition of claim 1, wherein the composition is substantially free from any phenyl containing constituents.

6. The composition of claim 1, wherein the composition is cured.

7. The composition of claim 1, wherein the composition is substantially free from benzene or benzene derivatives.

8. The composition of claim 1, wherein the composition is completely free from benzene or benzene derivatives.

9. The composition of claim 1, wherein the composition comprises low or substantially no residual aldehyde content or residue.

10. The composition of claim 9, wherein the composition has less than about 100 ppm aldehyde content or residue.

11. The composition of claim 1, wherein the composition further comprises diisopropanol toluidine and dimethyl piperazine.

12. The composition of claim 3, wherein the DLP is present from about 0.5 weight percent to about 5.0 weight percent based on the total weight of the composition

13. The composition of claim 12, wherein the DLP is present at about 1.0 weight percent to about 2.5 weight percent based on a total weight of the composition.

14. The composition of claim 4, wherein the PDHP is present from about 0.01 weight percent to about 1.0 weight percent based on a total weight of the composition.

15. The composition of claim 14, wherein the PDHP is present at about 0.1 weight percent based on the total weight of the composition.

16. The composition of claim 1, the composition comprising a two-part adhesive, the two part-adhesive comprising the DLP and the acrylic monomer in an A-side, and the PDHP in a B-side.

17. The composition of claim 16, further comprising a stabilizer.

18. The composition of claim 17, wherein the stabilizer comprises Ethanox 330.

19. A two-part adhesive composition, the two-part adhesive composition comprising:
an A-side comprising dilauroyl peroxide (DLP) and an acrylic monomer; and
a B-side comprising 3,5-diethyl-1,2-dihyrdro-1-phenyl-2-propylpyridine (PDHP).

20. The two-part adhesive composition of claim 19, further comprising a stabilizer.

21. The two-part adhesive composition of claim 20, wherein the stabilizer comprises Ethanox 330.

22. The two-part adhesive composition of claim 19, wherein the DLP is present from about 0.5 weight percent to about 5.0 weight percent based on a total weight of the composition.

23. The two-part adhesive composition of claim 19, wherein the DLP is present at about 1.0 weight percent to about 2.5 weight percent based on a total weight of the composition.

24. The two-part adhesive composition of claim 19, wherein the PDHP is present from about 0.01 weight percent to about 1.0 weight percent based on a total weight of the composition.

25. The two-part adhesive composition of claim 19, wherein the PDHP is present at about 0.1 weight percent based on a total weight of the composition.

26. The two-part adhesive composition of claim 19, wherein the composition is substantially free from any phenyl containing constituents.

27. The two-part adhesive composition of claim 19, wherein the composition is substantially free from benzene or benzene derivatives.

28. The two-part adhesive composition of claim 19, wherein the composition comprises low or substantially no residual aldehyde content or residue, optionally wherein the composition has less than about 100 ppm aldehyde content or residue.

29. The two-part adhesive composition of claim 19, wherein the composition further comprises diisopropanol toluidine and dimethyl piperazine.
